(19) United States
(12) Patent Application Publication
(10) Pub. No.: US 2010/0318475 A1
(43) Pub. Date: Dec. 16, 2010

(54) Method for meeting U.S. government security controls under export control regimes

(76) Inventor: James A. Abrahamson, Longboat Key, FL (US)

Correspondence Address: Dykema Gossett PLLC, Suite 300 West, 1300 I Street , N.W., Washington, DC, 20005-3306, US

(21) Appl. No.: 12/805,793

(22) Filed: Aug. 19, 2010

Related U.S. Application Data
(63) Continuation of application No. 11/562,754, filed on Nov. 22, 2006, now abandoned.
(60) Provisional application No. 60/825,164, filed on Sep. 11, 2006.

(51) Int. Cl. G06Q 90/00

(52) U.S. Cl. 705/500

(57) ABSTRACT

A business method which enables full conformance and probable approval within the U.S. International Export Controls, such as the Export Administration Regulation (EAR); the International Traffic in Arms Regulation (ITAR); and the international Missile Technology Control Regime (MTCR) even though the item may normally be precluded from export. The method includes filing an application for a license to exploit the technology; and including in the application commitments by the participants to comply with and follow certain security related procedures, including a service lease, security compliance training; pre-approval of technical disclosures; and operations and task compartmentalization among the parties.

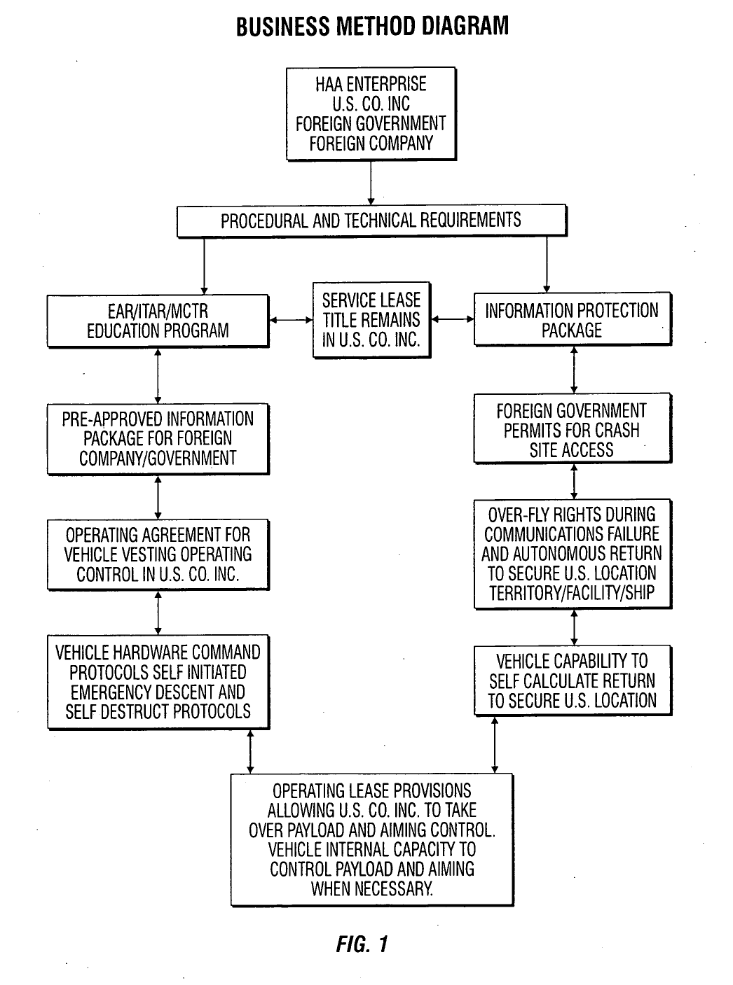

### CROSS REFERENCE TO RELATED APPLICATION

This application is based on provisional Application No. 60/825,164, filed Sep. 11, 2006, the teachings of which are incorporated herein by reference.

### BACKGROUND OF THE INVENTION

The invention is directed to a method for achieving a way of exploiting certain technologies which may be subject to certain security requiremens imposed by U.S. Government regulations. These requirements include restrictions and protocalls relating to the handling, transfer and exportation of certain technologies and access restrictions to such technologies. As part of such requirements, approvals and permissions are required before such technologies may indeed be transferred or accessed. In particular, the invention is related to certain contractual and technical arrangements, combined in such a way as to expedite the approvals process.

The invention is particularly directed to a business concept (with accompanying technical design features and programs) to allow successful and efficient compliance with EAR, ITAR, or MTCR regulations governing international licensing and exploitation of “dual use” technologies, such as, for example, a high altitude airship, (HAA), i.e. a stratospheric airship, and other unmanned aerial vehicles (UAVs).

The following statutes and regulations are relevant to the implementation of the invention and are incorporated herein by reference: United States Export Control Act of 1949; U.S. Department of Commerce Export Administration Regulations as revised 25 Mar. 1996; U.S. Department of Commerce Control List; United States Export Control Act of 1954 and 1979; U.S. State Department International Traffic in Arms Regulations; U.S. State Department U.S. Munitions Control List; the Missile Technology Control Regime, a voluntary association of 34 countries which seeks to limit the proliferation of ballistic missiles and weapons of mass destruction through a treaty and ongoing treaty interpretations. It is assumed that for purposes of this disclosure, if changes in the law or regulations as they exist today are made by the Congress or relevant agency, these law changes and new regulations may be relevant, and the method steps may require modification to comply with such changes. However, it is believed that the basic thrust of the invention would generally remain unchanged.

Under traditional procedures, it is virtually impossible to export certain highly restriced technologies without special enabling legislation. For example, jet aircraft and missle technology is usually governed this way. However, sometimes the persons who are responsible for classifying technology may, because of technical definitions, classify a technology in the most restrictive classification. Accordingly, if a technology is so classified, it becomes difficult if not impossible to conduct any meaningful business in order to exploit the technology, particularly outside of the United States.

In the case of the HAA, although one might not ordinarily think of an airship as such, under the MCTR, because the airship has a certain range and certain payload capacity, it may technically be classified as a missle. One normally would not so classify as such, but because the airship has certain capabilities, it fulfills one or more of the functions of a missle, even though it does not look or even work like a missle, and thus it may not be exported.

Thus, a need exists for a method making it possible to structure an arrangement which would allow for the exploitation of highly restricted technology without running afoul of export restrictions and other requirements, and at the same time addressing the legitimate security concerns of the United States. Indeed, it would be desirable to elicit the cooperation of U.S. authorities in such endeavor.

### BRIEF DESCRIPTION OF THE DRAWINGS

The drawing is a flow diagram illustrating the various steps for implementing the method of the present invention.

### SUMMARY OF THE INVENTION

The invention is based upon the discovery that a certain arrangements may be implemented which will allow U. S. entities to successfully exploit highly restricted technologies, while at the same time, in a cooperative effort with U.S. authorities, complying with the numerous statutory and regulatory requirements necessary to obtain the authorization(s) to do so.

The invention is directed to a method for controlling sensitive technical information to meet U.S. Government restrictions and controls for protecting the national security. In an exemplary embodiment of the invention, the method is employed to clear for use outside of the United States, a High Altitude Airship (HAA) or vehicle, representing a dual use technology under EAR and ITAR.

According to the invention a combination of specialized arrangements for controlling ultimate ownership of the vehicle; the technical information relating to it, its operations; and safeguards regarding recovery of the vehicle enables exploitation of a dual use technology by customers outside the United States. Although the vehicle is not exportable under EAR and then the ITAR, it is possible using the arrangements provided herein to adequately address the security concerns of the United States and yet allow for the utilization of such dual use technologies in the international market place.

According to the invention, the method employs a series of steps which allow an applicant such as a U.S. entity or individual (hereinafter U.S. national) to obtain U.S. government approval in order to exploit dual use technologies. In particular, the applicant files an application to the appropriate government agency or department, e.g. the Department of State. The application requests permission to exploit the technology in cooperation with a foreign entity or individual (hereinafter foreign entity). The application avoids the traditional expedient of arranging a sale of the technology, but instead employs a service lease arrangement, thereby technically avoiding exportation of the technology. In other words, the invention is not exported, even if it physically outside of the United States, if its not actually sold to a foreign entity. The service lease is implemented in a lease agreement, the terms and conditions of which become part of the application, and which terms and conditions must be approved by the agency as part of the application process.

In addition the application describes a compliance policy for protecting the technology. In particular, the compliance policy includes an education program for employees, vendors or other service providers employed or contracted by the U.S. entity. The education program, also subject to approval by the agency describes in detail, the training program for handing restricted technology. The training program would include an explaination of the law and regulations, and the responsibility of each person having access to the technology to comply therewith. In addition, the program would spell out in specific detail, among other things, procedures as to how the technology is to be actually handled; who has access to what; with whom may the technology be discussed; who may physically handle the technology or documentation; what happens if there is a breach of security. These procedures and others are designed to protect the technology and to assure the U. S. Government that the U.S. entity is fully prepared and able to comply with the law and regulations.

Yet another requirement of the application is an outline of that information which has been pre-approved for disclosure to the foreign entity during any negotiations conducted in connection with the lease agreement. This requirement enables the applicant and the foreign entity to intellegently discuss what it is that is being provided, without disclosing sensitive information. This provision thereby enables the parties to communicate without compromising security.

In order to implement the service lease arrangement, the U.S. entity and the foreign entity must enter into an operating agreement. This may be part of the lease or may be separate. The operating agreement outlines who will operate the vehicle and what kind of access to the vehicle the foreign entity will have. In the invention, the U.S. entity exercises control over the vehicle. That is to say, that the physical operation of the vehicle is under the control of the U.S. entity or U.S. citizens. These operations include navigation, flight control, emergency decent, control security and validation, and the like.

Yet another requirement of the operating agreement is an agreement to allow for control of the equipment or payload on board the vehicle. In cases where, for example a camera or antenna is aboard the vehicle, it is necessary to have agreements in place for secure aiming of such equipment. The foreign entity may be permitted to aim the camera or antenna, but may be under certain restrictions in order to avoid interference with other vehicles or facilities nearby. In other words, the payload operations are subject to restrictions as necessary to protect the U.S. national interest.

In connection with operations, there may be restrictions in place to limit the range of the vehicle, in order to guarantee that the vehicle is within range of a U.S. controlled remote recovery location to which the vehicle may be directed in case of an operational failure.

Finally, in the event of a catastrophic failure where the vehicle is so disabled that it is not possible to remotely recover the vehicle, arrangements may be put in place which allow persons to enter the foreign country in order to conduct recovery operations. In other words, permission to conduct recovery operations is pre-approved by the foreign government.

Thus, the invention is a method of providing particular technical information controls throughout the life of the international business relationship, and controls over the operation of the technology by changing the traditional business contracting method. At the same time, the invention employs tools which allow the parties to establish a meaningful and flexible business relationship because critical elements have been pre-approved by U.S. authorities. At the same time, the invention maintains strict control of vehicle technology; operations; related component and payload technologies; and vehicle recovery contingencies.

In addition to an HAA, the invention also applies to various other specialized or advanced technology high altitude vehicles, such as stratospheric airships, advanced unmanned aerial vehicles, and to other technologies as well. The invention enables the U.S. Government to ensure that operation of the technology is maintained in the hands of U.S. citizens and U.S. business entities; and meet technology control and non-proliferation restrictions.

### DESCRIPTION OF THE INVENTION

The U.S. Government has an inherent responsibility and legal right to approve or disapprove any application for export of technology under Export Administration Regulations (EAR) or International Traffic in Arms Regulations (ITAR). Further, the U.S. Government has a vital interest in properly controlling missile and other defense technology under the Missile Technology Control Regime (MTCR) for the protection of the nation. Accordingly, the invention addresses the vital and legitimate security concerns of the U.S. Government, while at the same time enabling legitimate and profitable commercial exploitation of advanced technologies which are often produced and developed in the U.S.

The drawing shows the various steps for implementing the invention in a flow chart like illustration. The invention combines key provisions of a specialized lease agreement, as well as the technical components and procedures outlined herein to ensure that the type of vehicle described will meet U.S. standards for technical information restrictions required to allow successful U.S. licensing under EAR, ITAR, or MTCR requirements.

Normally, EAR or ITAR license applications are processed in the following manner: A company wishing to export an item of technology checks with the U.S. Department of Commerce Control List for EAR applicability or the U.S. State Department Munitions Control List for ITAR applicability. If the technology fits into one of the two lists of technologies that require licensing, then the company “Registers” as a company interested in Export of a sensitive or controlled technology. The subsequent EAR licensing process is then simpler and usually much speedier. The Company fills out an EAR application form and turns it in for consideration by the Department of Commerce (DoC). The DoC may determine that the technology does not require additional controls, and they may issue a license with certain technology control items, or the Department of Commerce may coordinate with State Department ITAR personnel and notify the applicant that the company must apply for export within the ITAR requirement.

Alternately, it may be clear from the start, that the technology or the circumstances of the potential international customer require that the company must register under ITAR with the U.S. Department of State. Registration is relatively simple, but then the application usually requires a great deal of technical information about the vehicle or component or manufacturing process and the like. A lawyer who is a specialist on the ITAR process is usually engaged, and an extensive, highly interactive, process begins with compiling a significant description of the item, including all of components, tests, manufacturing processes, and operating procedures and the like. This large amount of information is submitted along with the ITAR application to the State Department, who in turn submit the information to interagency committees of experts from the State and Defense Departments as well as other representatives from the intelligence agencies, and the like.

If eventually the item is cleared, it is likely that one or more information restrictions are put in place. If the restrictions still allow “Export” of the item, then a Technical Assistance Agreement, is prepared, which identifies exactly what technical information is available to be released, and what information restrictions apply to the potential recipients of the information. The reason for the restrictions may be because the item represents sensitive technology that is being denied to various international customers, or it may be that exporting the item may be precluded because of the Missile Technology Control Regime (MTCR) or other U.S. treaties or embargoes.

Quoting from the MTCR website, for items controlled under MTCR, “the greatest restraint is applied to what are known as Category I items. These items include complete rocket systems (including ballistic missiles, space launch vehicles and sounding rockets) and unmanned air vehicle systems (including cruise missiles systems, target and reconnaissance drones) with capabilities exceeding a 300 km/500 kg range/payload threshold; production facilities for such systems; and major sub-systems including rocket stages, re-entry vehicles, rocket engines, guidance systems and warhead mechanisms.”

“The remainder of the annex is regarded as Category II, which includes complete rocket systems (including ballistic missiles systems, space launch vehicles and sounding rockets) and unmanned air vehicles (including cruise missile systems, target drones, and reconnaissance drones) not covered in item I, capable of a maximum range equal to or greater than, 300 km. Also included are a wide range of equipment, material, and technologies, most of which have uses other than for missiles capable of delivering WMD. While still agreeing to exercise restraint, partners have greater flexibility in the treatment of Category II transfer applications”.

According to the invention, there is provided a methodology whereby it is possible to craft arrangements for conducting business transactions which will allow for the commercial exploitation of highly restriced technologies while protecting national security interests. The invention is structured so as to encourage cooperation among the various parties to such transactions so that the process is expedited and efficient. The invention has been approved for at least one such transaction, resulting in a model which is readily adaptable for future arrangements of like kind

Service Lease Model

The invention recognizes that certain technologies are not easily exploited outside of the military context. In other words, technology which is primarily for military use is not appropriate subject matter for export. If such technology is exported, the exportation is usually governed by specialized enabling legislation. In other words, the technology is not exportable outside of special circumstances.

Other technologies, sometimes having both military and non-military applications, so called dual use technologies, may or not be exported depending on circumstances. Under the export controls regime, exportation means not only shipping physical hardware outside of the United States, but it also includes transfer of title; and communicating technical information outside the country. Indeed, it even means communicating information to a foreigner.

Recognizing this, in the first instance the invention avoids the transfer of legal title, and opts instead to an arrangement whereby the technology is governed by a special service lease arrangement. The contractual arrangement combines restrictions on the transfer of title with restrictions and controls for handling the technology. These arrangements seek to obtain a favorable decision by U.S. regulators whereby dual use technologies for vehicles and the like meet the technology control requirements of the U.S. EAR, ITAR, or MTCR, as interpreted by the U.S. State Department. The arrangement allows the export of services associated with those vehicles and technologies without exporting the technology as defined in the regulations.

The specific business arrangement is to lease of the vehicle other or technologies and provide services instead of a transfer of title. This kind of arrangement is the foundation of the method to acceptably conform to EAR, ITAR, and MTCR guidance. When combined with the other business and control techniques, set forth below, the service lease provides a secure and acceptable means for protecting the technology that the United States feels must be protected under ITAR, EAR, and under the international MTCR provisions.

It is important to point out that because the vehicle or other technology is not sold to an international business, or foreign government, and because title to the vehicle is not transferred to an entity or individual outside of the United States, i.e. the title remains with the American company or individual, actual “export” as defined in the regulations does not take place. However, it should be understood that mere leasing services rather than selling the vehicle with title transfer is not sufficient by itself to become an ITAR, EAR, or MTCR acceptable business arrangement for the United States. Other requirements are necessary as discussed below.

Educational Program

In addition to the hardware, it is also important not to transfer to a foreign entity or individual critical information on or about the vehicle or its payload. The first step in preventing the transfer of such critical information is to ensure that the U.S. company has in place a compliance training program in place to educate its employees, vendors and suppliers as to what is required in each situation. In addition, it is necessary to put in place a review process to further ensure compliance. This is a program for all employees who will come in contact with representatives of the international customer, ensuring that the concerned employees fully understand the provisions of the ITAR, EAR, or MTCR which protects key technical information on the vehicle and the specific protected information on how the vehicle is engineered, tested, and manufactured, as well as the details of how the vehicle, component or payload will be operated and controlled.

Pre-Approved Disclosure of Technical Information to Customer

The information necessary to enable the international customer to make a commitment is often itself subject to restriction under export controls. Export restrictions can defeat a sales campaign for an international customer on new vehicles or components, because the customer cannot be presented with the very information that provides it with the confidence to make a commitment for the new vehicle. This information allows the international customer to feel confident that the arrangement has commercial and technical viablility. Hence, it is vital to have a specific level of pre-approved information, properly specified in the license application that is acceptable to U.S. ITAR, EAR, or MTCR Government officials, and which is sufficient to instill the required confidence in the customer.

This allows the U.S. Government officials to join with the applying company and be fully engaged in the agreement on the specific level of information to be shared for confidence building. This pre approved information defines the threshold level of detailed technical information that could become enabling to an adversary of the United States and, thus, must be protected. An example of defining this threshold is to allow representatives of the international customer to see actual environmental or selected operating tests in process, or pictures of these tests in process, without detailing the specified levels of performance or the achieved test levels yielded in the test (which might divulge specified test margins, and the like).

Operating Agreement for Leased Vehicle or Technology

This feature of the invention comprises a special operating lease for the vehicle. The operating lease would specify the method by which the technology can be operated to meet customer requirements, while at the same time keeping the technology under U.S. control, from an operating center in the United States. In the case of an HAA, or stratospheric airship, for example, this is accomplished by the combination of the automated internal navigation and flight control system functions and the method of telemetry and satellite communications link control of the vehicle from a U.S. Control Center, as well as other technical components.

More specifically, the internal navigation and flight control systems would also contain one or more of the following features:

a) An internal vehicle capability for sufficiently autonomous control via internal commands or longer term operations input commands, so that the vehicle can continually operate over distances where satellite communication links (with their inherent delay times) can provide commands for vehicle control and safety during operations in any part of the world, or at least in the customer operating region.

b) Internal validation of input commands, so that the vehicle will recognize which inputs are legitimate U.S. commands versus a bogus command from someone else trying to usurp command and control of the vehicle, or input false commands or other means of hacking and hi-jacking the vehicle.

c) An internal protocol of default commands that will provide a series of reliable stored commands to the vehicle for operation in case of communications failure with the U.S. Command Center: i.e. in case of primary navigation command failure, then the vehicle design must include internal emergency commands for the vehicle to remain in place for a specified period of time; and then to return to a designated safe zone to await instructions or the like, and if new instructions are not received, to return to a U.S. base and descend to a given altitude for recovery operations.

d) The vehicle should have an emergency descent initiation and/or self destruct function for unanticipated failures.

Secure Aiming

Additionally, in the case of a vehicle or other aimable technology, the vehicle payload must have the technical means to aim and utilize the payload in accordance with the customer's legitimate mission objectives (those specified in the ITAR, EAR, and/or MTCR license TAA); without allowing payload actions which would compromise U.S. Force locations or related issues of U.S. security. For example, if the payload for an approved HAA vehicle mission is a scientific observation instrument such as a multi-spectral camera, to be normally used for approved earth observation for scientific or land use objectives; and the legitimate use is near enough to a U.S. deployed force that the camera output might compromise such force, then the vehicle and payload pointing system for the camera should include the technical provisions to control the payload and prevent immediate downloading of that data for readout at the customer's facility. This capability should be executable anywhere on the globe, or at least in the customer's operating region. This capability will also be able to serve as a final intervention in payload control and as such, the command system will be exclusively limited to be exercised by the United States or by a designated U.S. company during any and all vehicle and payload operations.

Range Limitations and Controls for Enabling U.S. Recovery

All vehicle operations and the vehicle will be controlled way and have vehicle range limiting factors, such that, during normal operations, the vehicle has the capability to reach U.S. territory; a U.S. base that is considered to be equivalent to U.S. territory, or U.S. ships at sea capable of recovering the vehicle or towing it to U.S. territory. if the HAA (or other vehicle) cannot be recovered, a self destruct function must be available.

On Site Authorization for U.S. Recovery in Foreign Locations

In a dire emergency, when the vehicle must or is coming back to earth because of a failure outside of U.S. territory, then the U.S. company must have emergency plans (which include customer country approvals) to put U.S. protection personnel in place at the landing or crash site when the vehicle lands or crashes. In addition, such approvals should allow U.S. recovery and maintenance personnel in place to perform any and all maintenance and repair functions to enable recovery, and to further protect the vehicle's technical information as well as to protect any appropriate U.S. licensed payload. These requirements must be within the provisions of the approved license.

Selectable Security Features

Finally, the business arrangement must include sufficient U.S. citizen involvement in appropriate U.S. companies, or in the vehicle, or payload documentation, or in the vehicle and payload training and operations documents, or in vehicle or licensed payload operations to protect the technical information as well as the specifically designated technical information limits that are standard in most technical export licensing. Exemplary thereof are the items set forth below which are specifically called out in the initial attached exemplary agreement, and which may be expanded or modified in any other specific TAA under consideration:

a) Software source code, operating algorithms, and program maintenance documentation.

b) Information that is generated in connection with the development of Missile Defense Agency's (“MDA”) HAA; ITAR controlled technical data on the HAA construction and manufacturing or materials technologies, systems optimization/integration know-how, or design know-how.

Information revealing capabilities, limitations or susceptibilities of U.S. Government (“USG”) systems and/or operations.

c) IFF Cryptographic IFF Modes.

d) USG tactics, doctrine, platform, or weapons system data.

e) USG data link algorithms, protocols, standards or secure data links.

f) Information related to specific payloads being developed for or to be used by MDA, or other U.S. security users of the HAV vehicles.

g) Design or technical analysis tools or methods of assessment (models, algorithms, databases, or software) which are not already in the public domain.

h) Technical data related to GPS will be limited to SPS (C/A code) only.

i) Information on USG image collection/processing

g) Restricted or controlled special process specifications

When U.S. Co. Inc. applies for first EAR approval and then later for ITAR approval, the applications may be rejected because the vehicle may meet the criteria of a missile under category I of the MTCR, and thus may not be exported to a foreign country. However, MTCR officials may be persuaded to approve an arrangement allowing exploitation of the technology if certain safeguards are implemented. Such safeguards the necessary elements to meet the intent of the MTCR for non-proliferation. A lease contract, the information and operational control for a HAV can obviate the prohibition on exportation by restricting the agreement to a lease without a transfer of title at the end of the lease as is typical in such arrangements. In other words, title remains in the U.S. supplier. Thus the need for an MTCR exception is avoided. Such an approval would allow the U.S. Co. Inc., to present the approved ITAR Technical Assistance Agreement to the Government of the foreign country for signature.

This approval and signing provides legitimate means of exporting HAA services. Thus, this contractual—technological, and operational controls combine to meet legitimate business needs while protecting U.S. security interests. The invention demonstrates that it can meet U.S. Government MTCR and ITAR restrictions, and allow the HAA (or perhaps other similar vehicles) to be leased for services to international customers.

The invention, includes the following five elements:

a) A unique contractual approach for leasing services utilizing the HAA that obviates the actual export of the technology.

b) An educational program to key U.S. employees of companies working on the technology that will come in contact with international customers. This program is to ensure that employees of the service provider fully understand the provisions and restrictions in the applicable TAA and a that a feedback; mechanism for evaluating the effectiveness of that program.

c) A thoughtful input to the design of the TAA that specifies a level of information required to provide potential international customers with sufficient confidence in the technology to be willing to pay vehicle leasing fees, acquire the payload equipment, and the like, while properly safeguarding precluded ITAR TAA information.

d) A Lease for the Operation of the technology far from the U.S. that provides specific protections such as, in the case of a vehicle, U.S. company flight control of the vehicle, while allowing sufficient customer country or company control of the vehicle payload operation to meet customer mission needs. The need to ensure U.S. vehicle control even if command communication links or similar command input systems fail, dictates that certain hardware and software backup commands must provide for continued U.S. vehicle control.

e) Similar to d above, the command and control of the payload must ensure that the customer has a responsive payload for the customer's mission needs, while also having a means for U.S. overriding capability to ensure that payload operations do not violate security issues or U.S. security constraints.

f) Operating plans and imbedded emergency commands to be included in the vehicle design which are re-plotting safe courses back to U.S. territory, U.S. bases, or to U.S. ships at sea and internal command structures which authorize the vehicle to follow these courses using its imbedded emergency command protocol.

g) Certain agreements with the international customer prior to deployment of the technology or operations to facilitate U.S. personnel to quickly travel to the projected crash site or extant crash site for protection of the technology surviving components and vital information and to support repair and recovery operations to ensure continued information protection in the unlikely event that the vehicle must return to earth outside of U.S. jurisdiction.

h) Careful U.S. involvement in the project, which oversees that other more standard or special AA information protection requirements are met in addition to the ones indicated above. Note: these may include key software codes, non-disclosable GPS codes, or other items specially called out by the U.S. Government in the approved TAA provisions.

The attached diagram shows a layout of how the method is implemented.

An exemplary lease agreement is attached behind the diagram. The lease has been negotiated with a foreign government. The names of the parties have been redacted, as not relevant to this discussion. The importance of the agreement is that it contains novel terms including an agreement to lease services, because if_there were a sale with a transfer of title, then there would automatically be an export event. This is an automatic and unacceptable event for a Category I MTCR vehicle technology. Thus, the customer is forced to accept an agreement providing for no transfer of title at any time during, or at the conclusion of the lease arrangement, which automatically forgoes owning the technology. Normally, the logistics support of such technologies might be so complex, and so unusual, e.g. lighter than air vehicles are highly different than aircraft, that the customer country would, in any event, contract the logistics support of the vehicle back to the U.S. Thus, the lease agreement is a reasonable business approach, especially for customers who would contract back the vehicle support and logistics.

Obtaining agreement from the customer that full vehicle and payload control would be accomplished through the lease provider for selected operations, and another for technologies for the exporter of services. This lease approach can be a very difficult point, one that requires significant trust in the lease provider and the customer relationship. However, unless the customer country is planning to use the technology in ways that that might be of concern so that the U.S. would disapprove; this should not be an overriding problem for the leased agreement.

Obviating the “export event” via a lease is not sufficient protection for the non-proliferation intent of MTCR or ITAR and, thus, the lease cannot be merely an isolated contractual way around the U.S. Government information transfer restrictions. The lease agreement must also be part of a program that includes special design features and acceptable operational controls and support agreements to provide the necessary assurance to the U.S. Government that the full program provides the additional and acceptable levels of anti-proliferation control for the technology.

Ensuring that the U.S. team developing and manufacturing the technology is fully cognizant of the provisions of the TAA and their own responsibility to abide by its provisions This provision is to ensure that key U.S. employees that are part of the overall technology development, manufacturing, and support teams are fully and properly prepared to handle their part in the information restriction role outlined in the TAA at all appropriate times. The proposed exporter of services will ensure that appropriate instruction sessions are developed and administered to the U.S. employees. For purposes of this patent application, these instructions are fairly standard in the proper administration of many U.S. Government contracts or are standard in commercial Non-Disclosure legal agreements, or standard in U.S. company ethics and IP protection programs. This education effort is specifically included in this provisional patent so that key U.S. employees will be fully aware of the restrictions and allowed areas of discussion with international customers that are extant in the appropriate ITAR licenses and TAA documents.

Providing customer confidence without disclosing information that would be of MTCR concern about “how to build” a vehicle that is classified as an MTCR “Missile’: This requires a creative and well analyzed structure to arrive at an agreement with U.S. State Department ITAR offices about the threshold of information that is acceptable for release versus the unauthorized transfer of information. In a high altitude vehicle exemplified herein a useful expedient would be to show pictures of key tests in progress or actually allow the customer to view tests in progress, without disclosing test specifications, goals or achieved performance. This allows the customer to be assured that all engineering is complete and has been tested, both from an operational viewpoint and from an environmental or even system viewpoint. Other equally useful venues can be defined for other vehicles or for a project or vehicle that is in a different place in its development and operational cycle. For example, there is little evidence that provides more confidence than to see a vehicle flying, or operating and to see payload information output from its operational environment. The results of an operational test program would usually have little to do with the principle issue associated with Class I MTCR “how to build the vehicle” information protection.

Another example, would be to authorize seeing the image of a ground target or weather observations of a hurricane in development, being photographed from a vehicle. This discloses nothing about the vehicle, but surely shows why it was developed and how it can be advantageously used in a mission scenario. This claim is not intended to be strictly limited to the examples discussed above. The claim is for this component of an integrated approach to protecting vehicle MTCR information, while providing confidence to a potential customer that the leased service investment is worthwhile and supports their mission applications. It is intended that invention will additionally cover other modifications and concepts that fall within the principal of this proposed protection element of providing a clear dividing line between confidence building for customers and unauthorized technical information that is one of the novel elements of the invention.

Operating the technology, e.g. a vehicle at a significant distance from the deployed vehicle, i.e. from the U.S. and that internal backup commands are available to provide emergency control of the vehicle in, case of command and control communications failure. This provision allows assurance to the U.S. Government, that the vehicle will not be misused, because the vehicle control is exclusively in the hands of a U.S. corporation and that the facilities for control are located in the U.S.

To provide assurance to the customer, that the vehicle is operating properly and will continue to operate properly, the approved vehicle TAA for the foreign country, allows a separate ground station to be placed in the customer country. This ground station is not to be a vehicle control center, it allows the customer to be aware of the continual stream of health telemetry so that the customer has confidence that the vehicle is operating within its proper margins (the telemetry to the customer must be modified so that it will not allow insight into how the vehicle is designed). The main function of the customer ground station is to allow the customer to receive sensor data and also to be assured that any payload telephony equipment, that may be part of the customer's mission, are operating properly.

To operate in locations, far away from the United States control center, the vehicle must have proper antennas and command and control communications gear to be continually controllable via communication satellite relays.

The vehicle must also have technical components that prevent others from gaining controlling of the vehicle. These emergency internal vehicle hardware and software components for preventing hacking into the vehicle command link (or other vehicle command link) and preventing takeover of the vehicle by another entity is a critical element of protecting the vehicle from misuse and protecting the vehicle technology. There are several existing communication link and command function protection devices and software components that are currently available to accomplish this protection function. These include the use of combinations of the following: periodically changed control software “keys”, special and/or variable coding of the commands, and software shields or firewalls. Again, this patent application is not an application for a specific type of any of the above shielding techniques. This patent application is only for the overall business—technology—and procedural concept that provides a mixture of technology controls that should then be licensable under EAR, ITAR, and MTCR restrictions.

The technical functions that must be included in the vehicle include a protocol of internal commands that provide temporary control and overriding actions in case of a telecommunications link or command insert failure. The stored internal commands should provide the following safeguards in case of external command link failure. To protect against a short-lived communications or command insert failure, the vehicle should have an internal fall-back command protocol that commands the vehicle to remain in place, wherever the vehicle is in its navigation mission sequence.

This first element of the command protocol is for remaining in place for a short, designated period of time, to resolve the problem. As stated above, the internal command stops all vehicle movement relative to the ground (this hover mode applies to a vehicle for another type of vehicle it may merely navigate in a circle or some related means of maintaining a safe restricted geographical location). i.e. A specific example of a vehicle is airship which would continue to remain at its operating altitude and countering prevailing winds: this allows the vehicle to hold over the point on the surface of the earth where it is presently operating. b) After the designated period of time remaining in one location, the second internal protocol would command the vehicle to internally navigate to a safe zone away from areas of communications interference, or potential enemy jamming. That is, if at the end of the designated time [(a) above], command and control of the vehicle is not re-established, then the next internal command would be exercised. This internal command would be for the vehicle to begin a retreat from the initial restricted operating zone, via a safe internally directed route to a location in a pre-designated safer zone. This would allow more time and an extra margin of safety while the communications link or command insert failure could be corrected, if possible.

c) The third internally stored protocol in the emergency recovery sequence outlined above, would be to resume flight along a pre-determined safe route to the nearest U.S. territory, a nearby U.S. base, or to an area to rendezvous with a U.S. ship at sea and descend to an altitude where the vehicle could be queried with higher powered command links to restore control or be recovered and towed to a proper recovery and repair location (under U.S. control). d) Finally, if none of the above in flight repair opportunities do not allow a solution of the command and control problem or a clear event of a total failure of the vehicle occurs, the vehicle or a related vehicle should include its own internal emergency descent initiation and/or its own internal self destruct mechanism. This would best be exercised at sea where the remaining debris would sink and be less likely to be recovered by an adversary.

Control of the Payloads under the lease arrangement is provided wherein the customer or a financing entity, may actually own the payload. However, the customer has entered into the special vehicle leasing arrangement because of the missions the proposed payload can carry out from the vantage point and utilizing the advantages of the proposed vehicle. The requirements of the ITAR TAA may include a variety of restrictions or policy controls over the payload. In the case of the vehicle the initial TAA for India requires the U.S. entity to be able to control or point the payload as well as the vehicle. If the vehicle is operating over the customer country's own territory or for scientific purposes that are consistent with a variety of U.S. policy controls, including EAR, ITAR, MTCR or other treaty or policy restraints, the payload could be a matter of some concern.

First, the payload may in itself be an item which is controlled under EAR or ITAR. In that case, the provisions for export or use of that payload may be completely separate and independent of its use on the HAA (or other vehicle). The ITAR TAA for the vehicle will in all likelihood note that there may be a need for a separate license for the payload. Second even if the planned use of the payload on the vehicle is acceptable, it may present some capabilities which should not be used in a way completely outside of U.S. control. Hence, the proposed vehicle should include its own independent command override, which allows the U.S. to assume pointing control when required. A technical capability to enable a time delay for delivery of the data to the customer country or company may also be required. Thus, the customer should be provided with as much independence and control over its payload as possible under various U.S. license provisions, but an override should be a technical capability that is available to meet contingent EAR, ITAR, MTCR, or other policy restraints.

In order to implement the internal backup command capability in the vehicle in accordance with the process outlined above, the vehicle must have the internal capability to develop a safe route for automated implementation along with the contingency command protocol. i.e. to stop and have the vehicle autonomously hold position, then to find its own safe route to a secure area for debugging or to U.S. territory—a U.S. Base—or to a U.S. ship at sea; the vehicle) must have its own internal data base of safe areas, and safe routes. Further, the safe routes must be kept current with the stratospheric airship or other vehicle's current operating position and updated so as to be consistently available for autonomous emergency recovery. The constant update and current safe routing data must also reflect up to date intelligence and relative safety rating inputs. Thus, this special subsystem, its data base, two way communications, and safe storage in the vehicle as well as the command center functions are a vital part of the vehicle or other vehicle's capability. This subsystem capability is the base internal autonomous technical capability which supports the command protocol element of this patent application, hence, both are vital parts of the technical implementation which provides assurance to the U.S. State Department. These are also shown in the attached.

The invention has conditions ensuring that proper arrangements and agreements are in place with international customers for emergency actions and protection, support, and repair functions if unanticipated failures occur and an vehicle descends or crashes in the customer country or other unprotected area. For the example of a stratospheric airship, such vehicle will not normally experience an extreme or precipitous crash from its normal operating altitude. If it is hit by a missile, or holes shot in it, or even if a rip in the fabric develops, the normal pressure inside the airship is only a small fraction above the atmospheric pressure outside of the hull. Hence, the leakage rate from a rip or reasonably sized hole in the fabric is very slow. Under those conditions, the hull slowly settles to slightly lower altitude. When the overall weight of the airship matches the lower buoyancy produced by the structure, payload, and weight of gas inside the airship, then the vehicle stops descending until more gas leaks out and the size of the hull shrinks, producing lower buoyant lift. Thus, unless there is major failure which destroys the structural stiffness of the hull, the emergency descent would be so slow that an air ship at normal altitude would take days, perhaps even weeks to descend to the surface.

Thus, the telemetry which is monitoring hull pressures and altitude, will normally provide a good indication that something has caused a leak rate that is exceeding the normal—extremely slow leak rate of the airship. Thus, when a significantly larger rate is confirmed (via telemetry data transmitted from the airship) there is also usually significant time to make a well justified decision to take the airship off of its mission station and begin to fly it back to U.S. territory, or to a U.S. base, or to rendezvous with a U.S. ship at sea.

These internal emergency commands should provide a high probability of a safe recovery that does not jeopardize the protected components or airship design concept that must be protected under the MTCR criteria. However, there is a very small, but finite probability that a major failure, such as an unprecedented major tear in the hull fabric or a successful attack by an adversary may cause a structural failure to occur. Should such a failure occur, once again the airship could still fall slowly if any significant helium is retained in the hull. Most times an airship would descend reasonably slowly, even in this extreme case; it would not be like an aircraft that is out of control or that has suffered a major structural failure and immediately crashes. In this more extreme case, the airship would descend in a matter of hours and land fairly near its mission operating track or geo-located reference point.

In this, unlikely scenario, protection of the crash site will become a matter of immediate concern. When the failure event begins, the crash site radius can usually be calculated, and a police or protection team should be immediately dispatched and they should be instructed to set up a perimeter protection zone around the crash site. A U.S. recovery and protection team should also be dispatched as quickly as possible. The lease agreement with a customer nation should contain pre-negotiated clauses to allow a U.S. protection and support team to assume immediate control over the crash site, and to make repairs or prepare the surviving airship wreckage to be shipped via controlled means to the U.S. This provision of the lease agreement should carefully pre-define the authority required to be able to utilize a U.S. protection and repair or shipping team over the crash site and the wreckage. To be prepared for an event of an impending full crash, a self powered, self destruct mechanism should be implemented in the design so that it can also be exercised via satellite transmitted signal to the airship before there is a loss of command signal reception.

In addition to ITAR MTCR Class I vehicle restrictions, the U.S. Government may include other more standard information restrictions, which must also be protected. The current HAA ITAR TAA for certain foreign countries include a list of additional more standard components or related information which must be protected as part of the ITAR license. These and other standard or special items may be covered as part of another vehicle ITAR TAA. Hence, the successful implementation of the necessary approvals, could not be properly implemented unless there was the system, procedures, and contractual provisions to add them to this model. Thus, all of the above are not sufficient assurance to the U.S. Government EAR, ITAR, and MTCR officials without the inclusion of a general class of information to be fully protected. This provision is that necessary administrative capability for this patent application.

The drawing is a diagram which helps the reader visualize the parts of the business concept—technical provisions in the design—and operating procedures which are the components of the proposed patent. The diagram includes the elements which are explained above, and which comprise the 8 claims above.

An exemplary of this business concept is one that includes the features shown in the drawing. Each of the elements are part of the overall information protection items, required to provide the U.S. Government the confidence to issue an EAR, ITAR, or MTCR compliant protection system for an HAA (or other related vehicle). It is assumed that certain ultra high altitude vehicles UAVs which also breach the parameters of the MTCR definition of a missile, could not be licensable in the same way that the U.S. State Department has refused to approve an ITAR TAA for technologies in some foreign countries.

The present invention has been implemented for a high altitude airship HHA, which was leased to a foreign government. The HHA is to be operated by a U.S. company, using U.S. personnel in accordance with the terms and conditions of the attached service lease agreement. The arrangement has been approved by the U.S. Department of State.

Some variations of this novel business concept are conceivable: For example, additional protection systems or technical components may be proposed which would add to the confidence that a leased high altitude airship or even an HAA sale might be possible which would not breach the current interpretation of the MTCR, Category I parameters that identify the HAA (or other vehicle) as a missile which cannot be exported from the U.S. However, this provisional patent application, as described with reference to specific embodiments, is not meant to be constructed or interpreted in a limited sense. Various modifications of the disclosed embodiments as well as alternative embodiments of the invention will become apparent to persons skilled in the art upon reference to the disclosures herein. It is, therefore, contemplated that the appended claims will cover such modifications that fall within the scope of the business concept, technology, and operational procedures and components which are the novel elements of this invention.

The following is an exemplary agreement between a United States entity, and a foreign country which has been entered into. The agreement includes reference to a foreign country which may also be made a party.

### Technical Assistant Agreement Between US Co. Inc. and Foreign Company/Government

TABLE OF CONTENTS

| SUBJECT | | PAGE NO. |
|---|---|---|
| General Purpose of Agreement | | 3 |
| ARTICLE 1: | Statement of Services and Shared Technical | 3 |
| | Assistance and Data | |
| ARTICLE 2: | Term and Termination | 6 |
| ARTICLE 3: | Meeting/Conference Sites | 6 |
| ARTICLE 4: | Notices | 5 |
| ARTICLE 5: | United States Department of State Required | 7 |
| | Clauses | |
| ARTICLE 6: | Assignment, Transfer, Delegation, or Sale | 7 |
| ARTICLE 7: | Agreement | 9 |

This Technical Assistance Agreement (hereafter referred to as “Agreement”), effective as of the date last signed, by and between US CO. INC.; FOREIGN GOVERNMENT;and FOREIGN COMPANY, shall constitute the terms and conditions for US CO. INC. to provide technical assistance, technical data, training, and leased lighter-than-air High Altitude Airships (“HAA”) flight operations and services, as identified in Article 3 of this Agreement, regarding the design, uses for, and operation of HAAs. The above mentioned companies may be hereinafter referred to individually as “the Party” or collectively as “the Parties” as appropriate.

General Purpose of Agreement

WHEREAS US CO. INC. is in the business of designing, developing, manufacturing, marketing, and in the future, leasing and operating HAA vehicles and providing HAA payload services;

WHEREAS, the FOREIGN GOVERNMENT, is in the business of mapping and making scientific observations of the atmosphere and surface area and surrounding ocean areas of the nation of FOREIGN GOVERNMENT; and FOREIGN COMPANY. is in the business of providing commercial telecommunications and related services to the FOREIGN GOVERNMENT; and

WHEREAS, all Parties wish to exchange information regarding the design, operation, performance, and certain payloads and services to be provided by leased HAA vehicles.

WHEREAS, the Parties have represented to each other that each one is in lawful possession of the information which is the subject matter of the export under this Agreement and holds or will hold the requisite Governmental approvals of their respective countries as may be necessary or required for possession and/or dissemination of information.

Therefore, the purpose of this Agreement is to permit export of technical data and design services related to design, analysis, manufacture, inspection, and operation of HAAs as agreed to in the following articles.

ARTICLE 1: Statement of Services and Shared Technical Assistance and Data

Per ITAR §124.7(1) describe defense article to be manufactured and all defense articles to be exported

No defense article will be exported under this Agreement. US CO. INC. will provide one or more HAA communications and scientific observation platforms to fly under US CO. INC.'s control, over the nation of FOREIGN GOVERNMENT with payloads to be determined under the direction of the Parties.

Per ITAR §124.7(2) describe assistance and technical data, including the design and manufacturing know-how involved
1.1 Under this Agreement, US CO. INC. shall, as per the requirements of, and the nature of business carried by respective parties, transmit the following types of technical data and defense services in support of this Agreement:
   1.1.1 Weather information at high altitudes over the nation of FOREIGN GOVERNMENT and it's surrounds. These are unclassified data, generated from the US NOAA 40 year Atmospheric Re-analysis Project (which is an international effort to gain historical atmospheric data from all over the world; this effort garners weather observation and atmospheric modeling information—classifies it for it's traceable validity—and combines it into a significant data base). The data is distributed on request—and for a fee—to individuals and companies from the National Center for Atmospheric Research (“NCAR”), in Colorado. This information is needed for this TAA so that potential HAA customers can assess the issues of airship power and energy storage requirements, and the airship's ability to stay on it's operating station or designated patrol, while countering stratospheric winds.
   1.1.2 Brochure type material on the HAA and it's construction and performance. This is selected material so that a potential HAA customer will know the vehicle that is being proposed for lease to accomplish specific data gathering, communication, or other related missions.
   1.1.3 Photographs of components under test or having completed test. This is so that a potential HAA customer can appreciate where the project is in it's development. These photographs are all selected to provide project confidence, but not to reveal proprietary information (e.g., technical data that would reveal specific detail on the tests (test parameters) will not be released).
   1.1.4 Some lists and examples of the generic types of payloads that could be carried on a HAA airship and the types of missions these payloads can accomplish when they are carried by a HAA, with it's potential persistence on station and long term endurance include: low resolution mapping camera, medium resolution multi-spectral camera for earth resources study, atmospheric instrumentation and civil commercial wireless transmitters and receivers. Also US CO. INC. will provide basic generic information on communications connectivity (i.e., how a HAA based wireless communications capability would interface into the satellite segments of the international long distance carrier systems, and how telephone calls can be multi-plexed and sent via HAA signals to ground-based receivers and transmitters and through those receiving and transmitting stations into and from the potential customer's existing wireless and wire-line telephone system). Similarly, US CO. INC. will include a general description of how an earth resources observing version of the HAA would send it's data to the ground.
   1.1.5 Market information on certain types of services. These are mostly U.S. or other nation's business models and basic information for wireless telecommunications applications, or earth resources information. These allow the potential customer some understanding of just how the HAA can change the telecommunications or observation paradigms as well as allow the potential customer an approach to be able to calculate the benefits that HAAs can provide to them and to their nation.
   1.1.6 Leasing costs, estimated insurance costs, estimated support costs, and other pricing information. These will assist a potential customer in determining the cost-effectiveness, price, and affordability of a HAA system.
1.2 Under this Agreement, and pursuant to DDTC approval letter, US CO. INC. will not transmit the following types of technical data and defense services:
   1.2.1 Software source code, operating algorithms, and program maintenance documentation.
   1.2.2 Information that is generated in connection with the development of Missile Defense Agency's (“MDA”) HAA; ITAR controlled technical data on the HAA construction and manufacturing or materials technologies, systems optimization/integration know-how, or design know-how.
   1.2.3 Information revealing capabilities, limitations or susceptibilities of U.S. Government (“USG”) systems and/or operations.
   1.2.4 IFF Cryptographic IFF Modes.
   1.2.5 USG tactics, doctrine, platform, or weapons system data.
   1.2.6 USG data link algorithms, protocols, standards or secure data links.
   1.2.7 Information related to specific payloads being developed for or to be used by MDA.
   1.2.8 Design or technical analysis tools or methods of assessment (models, algorithms, databases, or software) which are not already in the public domain.
   1.2.9 Technical data related to GPS will be limited to SPS (C/A code) only.
   1.2.10 Information on USG image collection/processing
   1.2.11 Restricted or controlled special process specifications
1.3 The HAA and payloads will only be controlled from the U.S. FOREIGN GOVERNMENT will not be able to control the HAA or its payloads. FOREIGN GOVERNMENT will receive HAA telemetry consisting of health monitoring and payload collected information.
1.4 The HAA will only descend below the stratosphere over U.S. territory. Prior to lease, US CO. INC. will ensure that provisions are in place to protect all ITAR controlled hardware in the event of an emergency descent. In the event of an emergency descent, all repairs will be performed by U.S. personnel.
1.5 The HAA will have provisions for autonomous navigation and flight control in the event that active flight control is lost. HAA communication systems will include an anti-jam feature to prevent hacking and hijacking of the HAA.
1.6 The Parties will submit an amendment to the TAA for approval for information on specific payloads, their capabilities and their integration into the HAA system.
1.7 The parties will submit a separate request to USG for final system configuration and hardware transfer(s).
1.8 This TAA will not prejudice DODs right to review and approve proposed transfers of technology developed in connection with MDAs HAA Program based upon existing or future agreements with US CO. INC., Lockheed Martin, or any other contractor working on the HAA Program.

ARTICLE 2 Term and Termination

Per ITAR §124.7(3) specify duration of agreement
2.1 This Agreement will become effective only after it has been signed by all Parties and written approval by the United States Department of State, Office of Defense Trade Controls has been secured. This Agreement will remain in effect until 31 Dec. 2014. US CO. INC. will advise from time to time the Government of FOREIGN GOVERNMENT, and FOREIGN COMPANY including its subsidiaries/affiliates, on any approvals, sanctions, permissions, consents, filings, that may be necessary or required by each of them in the United States in connection with possession, use and dissemination of the information under this Agreement.
2.2 This Agreement will terminate if the Department of State at any time revokes its approval.
2.3 Without prejudice to any other remedies which may be available, either Party will have the right to terminate this Agreement by giving thirty (30) days written notice of its intention to do so. The receiving Party will confirm receipt of such notice, and this Agreement will be considered as terminated on the expiration of the said thirty (30) days.

ARTICLE 3: Meeting/Conference Sites

Per ITAR §124.7(4) identify the countries or areas in which manufacturing, production, processing, sale or other form of transfer is to be licensed.
3.1 Defense services and technical data provided by US CO. INC. under this Agreement shall be provided to the Parties at their facilities located at NAMED LOCATIONS.
3.2 The HAA design and payload integration work will be performed at US CO. INC. AT NAMED FACILITIES. at some payload providers in FOREIGN GOVERNMENT or in the United States. We recognize and agree that certain payloads may require separate export licenses which will be obtained at our cost. US CO. INC. will advise the Parties of such licenses as and when required for fulfilling its obligations under this Agreement.
3.3 Technical meetings and conferences may take place at any of the Parties' facilities located at the above sites in FOREIGN GOVERNMENT or at the sites mentioned above in the United States.

ARTICLE 4: Notices
4.1 All notices hereunder will be in writing and personally delivered and/or sent by registered mail or telegraphic/electronic means to the representative Parties at the following addresses, which may be changed by written notice to the following locations:
NAMED LOCATIONS OF
US CO. INC.
FOREIGN COMPANY;
FOREIGN COUNTRY;
OTHER LOCATIONS.
4.2 The date on which any such notice is received by the addressee is the effective date of such notice.

ARTICLE 5: United States Department of State Required Clauses

Statements Required by ITAR §124.8
5.1 The provisions of the following paragraphs, required per 22 C.F.R. 124.8 will apply to this Agreement, and in the event of a conflict, will take precedence and be controlling over any and all other provisions of this Agreement. Neither these provisions nor any waiver of them by the United States Government will be interpreted to, or in any way, grant the Parties, by implication or otherwise, any right not otherwise expressly granted under this Agreement.
5.2 This Agreement will not enter into force, and will not be amended or extended, without the prior written approval of the Department of State of the U.S. Government.
5.3 This Agreement is subject to all United States laws and regulations relating to exports and to all administrative acts of the U.S. Government pursuant to such laws and regulations.
5.4 The Parties to this Agreement agree that the obligations contained in this Agreement will not affect the performance of any obligations created by prior contracts or subcontracts which the parties may have individually or collectively with the U.S. Government.
5.5 No liability will be incurred by or attributed to the U.S. Government in connection with any possible infringement of privately owned patent or proprietary rights, either domestic or foreign, by reason of the U.S. Government's approval of this Agreement.
5.6 The technical data or defense service exported from the United States in furtherance of this Agreement and any defense article which may be produced or manufactured from such technical data or defense service may not be transferred to a person in a third country or to a national of a third country except as specifically authorized in this Agreement unless the prior written approval of the Department of State has been obtained.
5.7 All provisions in this Agreement which refer to the United States Government and the Department of State will remain binding on the parties after the termination of the Agreement.
5.8 US CO. INC. represents and warrants to the Parties to this Agreement that (i) it lawfully possesses the information (such as technical data and defense services) as referred to in Article 1.1 above; (ii) it has the requisite sanctions, approvals, permits, licenses as may be necessary or required to disseminate information under this Agreement; and (ii) the information to be disseminated under this Agreement does not and will not infringe any intellectual property rights (whether registered or unregistered) including privately owned patent or proprietary rights either domestic or foreign in any manner whatsoever.

ARTICLE 6: ASSIGNMENT, TRANSFER, DELEGATION OR SALE
6.1 This Agreement shall inure to the benefit of, and shall be binding upon, each of the Parties hereto and their respective successors and assignees, but shall not be assigned in whole or in part by either Party without written consent of the other Parties hereto.
6.2 If the Agreement grants any rights to sublicense, prior to the release of any technical data, the sublicensee must execute a Non-Disclosure Agreement (NDA) incorporating all the provisions of the basic agreement which refer to the U.S. Government and the Department of State (i.e., 22 C.F.R 124.8 and/or 124.9). Copies of the executed NDAs, referencing this ODTC case number, must be maintained by US CO. INC. for five years from the expiration of the agreement.
6.3 Shipment of hardware against this agreement by separate license is authorized (e.g., DSP-5). If used, separate license must reference this agreement and must not exceed $100,000 US Dollars. Shipment of hardware against this agreement under the provisions of 22 C.F.R 123.16(b)(1) is not authorized and may take place only after the Department of State approves an amendment to the agreement that incorporates the requirements of 22 C.F.R 123.16 (b)(1)(i).
6.4 It is planned that this agreement will not result in the shipment of hardware, and will be limited to leasing of High Altitude Airship based services only. Hence no transfer of title will occur. Airships will be flown from the United States and operated over or near the nation of FOREIGN GOVERNMENT but only under US CO. INC. LLC control, but responsive to the payload control desires of customers in the FOREIGN GOVERNMENT.

ARTICLE 7: AGREEMENT
7.1 This Agreement constitutes the entire Agreement with respect to the subject matter hereof and supersedes any prior agreements, either written or oral, with respect to the subject matter hereof. This Agreement may be amended only by a written instrument signed by the duly authorized representatives of the Parties hereto.

IN WITNESS WHEREOF, the Parties hereto have caused this Agreement to be executed in duplicate counterparts by their duly authorized officers or representatives as of the day and year last written as follows:

US CO. INC

By:
Name:
Title:
Date:

Name of Other Parties are listed and to be signed for those Parties below:

FOREIGN GOVERNMENT

By:
Name:
Title:
Date:

Department of Science and Technology of FOREIGN GOVERNMENT

By:
Name:
Title:
Date:

FOREIGN COMPANY

By:
Name:
Title:
Date:

What is claimed is:

1. A method for allowing a United States entitiy to commercially exploit highly restricted mobile technologies in order to allow a foreign entity to perform task objectives while complying with statutory and regulatory requirements of the United States, said requirements including the necessity to obtain permission from a U.S. authority authorized grant such permission before such exploitation, comprising the steps of:
filing an application to the appropriate government agency or department for a license to exploit the technology in cooperation with a foreign entity;
preparing a service lease agreement said agreement between the U.S. entity and the foreign entity, said service lease maintaining title to the technology in the U.S. entity at all times;
establishing a compliance policy instituting procedures for handling the technology in accordance with U.S. law and regulations;
training personnel employed by the U.S. entity as to the procedures;
obtaining a body of pre-approved technical information for disclosure to the foreign entity in order to allow the foreign entity to intellegently discuss what technology and service is being provided, without disclosing sensitive information;
preparing a task agreement between the U.S. entity and the foreign entity whereby the foreign entity controlls selected non-security related portions of the technology commensurate with the task objectives to be performed;
preparing an operating agreement between the U.S. entity and the foreign entity whereby the U.S. entity controls selected security related operations of the technology and components thereof including provisions governing navigation, aiming, range and recovery accessability out side of the United States.

2. The method of claim 1 wherein the mobile technology comprises a high altitude airship (HAA).

3. The method of claim 1 wherein the terms and conditions of the agreements are subject to approval by the U.S. authority.

4. A method for allowing a United States entitiy to commercially exploit a vehicle classified as dual use technology in order to allow a foreign entity to utilize the technology to perform task objectives while complying with statutory and regulatory requirements of the United States, said requirements including the necessity to obtain permission from a U.S. authority authorized grant such permission before such exploitation can legally occur, comprising the steps of:
filing an application for a license to exploit the technology;
preparing a service lease agreement whereby title to the vehicle remains in the U.S. entity at all times;
establishing a compliance policy for handling the technology in accordance with U.S. law and regulations;
training personnel employed by the U.S. entity as to the policy;
obtaining a body of pre-approved technical information for disclosure to the foreign entity;
preparing a task agreement for allowing the foreign entity to perform certain functions commensurate with the task objectives to be performed;
preparing an operating agreement between the U.S. entity and the foreign entity whereby the U.S. entity controls selected security related operations including navigation, aiming, range and recovery accessability without the United States.

5. A business method which enables full conformance and probable approval for the exploitation of a resticted technology, by participants including U.S. and non-U.S. entites, even though technology may normally be precluded from export within the U.S. International Export Controls, such as the Export Administration Regulation (EAR); the International Traffic in Arms Regulation (ITAR); and the international Missile Technology Control Regime (MTCR), the method comprising the steps of:
filing an application for a license to exploit the technology;
incorporating in the application commitments by the participants to comply with and follow certain security related procedures, including an agreement by the non U.S. participant to a service lease where title to the technology remains in a U.S. entity, an agreement to perform security compliance training for personnel; obtaining pre-approval of technical disclosures to the non-U.S. entity; and compartmentalization of operations and task functions between the U.S. and non U.S. participants.
